(19) United States
(12) Patent Application Publication
(10) Pub. No.: US 2002/0171162 A1
(43) Pub. Date: Nov. 21, 2002

(54) Strong durable low cost composite materials

(76) Inventors: Izhar Halahmi, Hod Hasharon (IL); Mike Gross, Hod Hasharon (IL); Ian Leonard Jacobs, Zichron Yaacov (IL)

Correspondence Address: FLESHNER & KIM, LLP, P. O. Box 221200, Chantilly, VA, 20153-1200, US

(21) Appl. No.: 09/813,876

(22) Filed: Mar. 22, 2001

(51) Int. Cl. B29C 45/00

(52) U.S. Cl. 264/37.27; 264/320; 264/328.2; 264/921

(57) ABSTRACT

The present invention concerns treated fibrous porous material having a defined nanostructure comprising reactive sites thereon, wherein said fibrous porous material is treated with a low viscosity organic solution comprising CCA1. The treated fibrous porous material is further mixed with a resin to form a composite. The composite may be formed by various methods of mixing and molding. The invention is further directed to various composites made therefrom. The fibrous porous material is selected from the group comprising cellulose, lignin, synthetic ceramics, porous metal nanopowders, kaolin, bio fibers and porous powders of biological origin or their mixtures. The resin may be any polymer obtained from industrial or domestic waste, and is selected from the group comprising polyethylene and copolymers thereof, polypropylene and copolymers thereof, polystyrene and copolymers thereof, polycarbonate, silicones and copolymers thereof, polybutylene or polyethyleneterphthalate, polyurethane, epoxy, unsaturated polyesters, vinyl esters and ethers, acrylic resins and copolymers thereof, polyamides, phenolics, amino resins, alkyds, polyimides, polyethers, polyvinyl chloride and copolymers thereof, nylon or mixtures thereof.

### FIELD OF THE INVENTION

This invention relates to composite materials. More specifically it relates to composite materials made from cellulose fibers and resin.

### BACKGROUND OF THE INVENTION

Organic composites are built from polymeric matrix and solid, hard particulate or fibrous reinforcement. Typical reinforcing materials are inorganic fillers such as silica, talc, alumina, glass spheres, calcium carbonate, ceramic powders, silicon carbide, inorganic fibers such as glass, carbon, ceramic, boron and organic fibers such as kevlar, cellulose, lignin, and nylon. When the particles of the added solid material are small enough (500 nm and less) and are compatible with the polymeric matrix, the properties of the mixture are nonlinear, due to the interaction polymer-particle on the molecular level (Tie Lan, Ying Liang, Gary W. Beall and Karl Kamena, Nanocor Incorporated, Corporate Technical Center, Arlington Heights, Ill. USA, in “Advances in Nanomer® Additives for Clay/Polymer Nanocomposites”). Such composite materials are termed nanoparticles and exhibit better strength and order.

In order to stabilize the composition of polymer matrix and additives some mediating agent is necessary. Surfactants are known to stabilize solutions composed of immiscible solvents. The same phenomenon occurs in polymers where polymers of different molecular structure upon mixing together by melting or in solution, tend to separate into multi-phase structure resulting in a mixture having inferior physical properties compared to the original resin components. In order to mix together polymers having different basic repeating units, molecular weight, branching rate, polymers which differ in their end and pendant groups or in the nature of stereoisomerism, polymers with a different degree of crosslinking or of acid-base interactions, surfactants-like entities should be added to the polymeric mixture. These surfactant-like entities known as compatibilizers, stabilize the polymeric blend and give rise to improved mechanical, physical and chemical properties of the blend. The added compatibilizers which are polymeric, stabilize the phases and enable creating multi-phase compositions with practical value (Datta Sudhin, Loshe David J. Polymeric compatibilizers—uses and benefits in polymer blends., Hanser Publishers 1996). Compatibilizers, in addition to stabilizing polymer-polymer interactions, further serve as polymer-filler interface (Eastman publication APG-Jul. 10, 1998). In the case where a hydrophilic filler or reinforcement like cellulose in mixed together with a hydrophobic matrix (e.g. polyethylene or polypropylene) the presence of the compatibilizer is crucial. In such a case, e compatibilizer blocks the hydroxyl groups and seals the surface of the particle (U.S. Pat. No. 6,117,545). The disadvantage of compatibilizers limiting their use is their relatively high price and high viscosity. Furthermore, the high viscosity dictates that they be mixed only in high-shear/high-temperature equipment extruder. Also their formulation is very sensitive to processing conditions, and their treatment is limited to the outer surface of particles and fibers, a severe drawback when dealing with porous particles.

Another approach to stabilize a composition of polymer(s) and additives may be the use of coupling agents. These agents, unlike compatibilizers that encapsulate the particle/polymer phase, are low molecular weight reactive molecules that have multifinctionality that enable the chemical bridging between solid and polymer (“Tailoring Surfaces with Silanes”, Chemtech, Vol. 7, 766-778, 1977). The mode of action of the coupling agents is by forming covalent bonds to the different components. Their advantages are good penetration into porous materials, high reactivity inorganic compatibility, easy to apply at relatively low cost mixing equipment. However, they are volatile (imparting economic and environmental problems), and tend to migrate from interfaces thus being poor compatibilizers. In addition, their chemical reactivity spectrum is rather limited.

Cellulosic fiber composites and nanocomposites are described for example in U.S. Pat. No. 6,103,790 - “Cellulosic microfibril reinforced polymers and their application”, U.S. Pat. No. 5,973,035—“Cellulosic fiber composites”, and U.S. Pat. No. 6,066,680—“Extrudable composite of polymer and wood flour”.

### SUMMARY OF THE INVENTION

The present invention is based on the findings that composite materials having improved physical properties may be obtained by mixing a resin and chemically treated material. The material is a fibrous porous material having a defined nanostructure comprising reactive sites thereon wherein the treatment is carried with a low viscosity solution comprising of Cycletec Coupling Agent 1 (hereinafter CCA1, produced by Recycling Technologies Ltd., Israel). The resin may be any thermoplastic or theremosetting polymers, or multilayered or multicomponent, their mixtures, in particular from post consumer plastic mixture. The porous material is selected from the group comprising of cellulose, lignin, synthetic ceramics, porous metal nanopowders, kaolin, bio fibers and porous powders of biological origin or mixtures thereof.

It is thus one object of the present invention to provide a treated fibrous porous material having a defined nanostructure comprising reactive sites thereon, wherein the fibrous material is treated with a low viscosity organic solution comprising Cycletec Coupling Agent 1.

It is a Further object of the present invention to provide composites made of a resin and the chemically treated fibrous porous material serving as filler.

It is also an object of the present invention to provide a method of manufacturing a composite comprising of a resin and an additive wherein the additive is a fibrous porous material having a defined nanostructure comprising reactive sites thereon wherein said additive is treated with a low viscosity solution comprising CCA1. According to the invention after mixing the resin and filler the solvent is removed. The resulting composition of the resin and filler are mixed or extruded in standard extrusion equipment, wherein the mixing or extrusion are carried at an ambient or elevated temperature. The resulting composition is further molded immediately after extrusion, or cooled down to give a preform that is preheated and compression molded at a temperature of from about 120° C. to about 190° C. under a pressure of from about 10 to about 60 atm.

It is yet a further objection of the present invention to provide products such as plates, boards, films, carrying surfaces manufactured from the composites made of resin and the filler and manufactured as described.

It is still yet a further objection of the present invention to provide a preform manufactured from the composite of the present invention by shaping the extruded or mixed composite to give a sheet of material.

It is also the object of the present invention to provide a preform manufactured from the composite of the present invention by impregnating the extruded or mixed composite into a woven or non-woven fabric to give a sheet of material.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic representation of the resulting microscopic structure obtained by the present invention as compared to the structure obtained by using prior art compatibilizers.

FIG. 2 Is a schematic representation of a composite structure made from a core of composite material of the invention laminated by a reinforced fabric.

### DETAILED DESCRIPTION OF THE INVENTION

The present invention provides a treated fibrous porous material for use as a reactive additive for composite materials. The treated fibrous porous material serves as an additive for the manufacturing of composites. The fibrous porous material has a defined nanostructure with a high aspect ratio, good internal hydrolytic stability and high strength and modulus. The material should have reactive sites such as but not limited to hydroxyls, acidic or basic groups, ethers, esters, epoxides, amines, mercaptans or even a double bond. Such a fibrous porous material may be selected from cellulose, lignin, synthetic ceramics, porous metal nanopowders, kaolin, bio fibers and porous powders of biological origin or their mixtures. Preferably, the porous material is cellulose, which may be in the form of wood chips, newsprint material, paper chips or powder, sawdust or their mixtures. Most preferably the porous material is newspaper. The conversion of the fibrous porous agent to a useful reactive additive or filler for composites is carried out by treating the fibrous porous material with a low viscosity organic solution comprising of Cycletec Coupling Agent 1 (hereinafter CCA1), which is manufactured by Recycling technologies Ltd., Israel. CCA1 is dissolved in an appropriate organic solvent and the resulting solution is sprayed over the fibrous porous material. The amount of added solvent is from about 0 to about 20g. for each 100 g of filler, and from about 0.1 g. to about 25 g. of CCA1 for each 100 g. of filler. Commonly used solvents are aromatic, aliphatc, ethers, esters, ketones, halogenated solvents and alcohols. The solution treats the entire porous material unlike known compatibilizers, which modify only the surface while the inner porous structure is untreated.

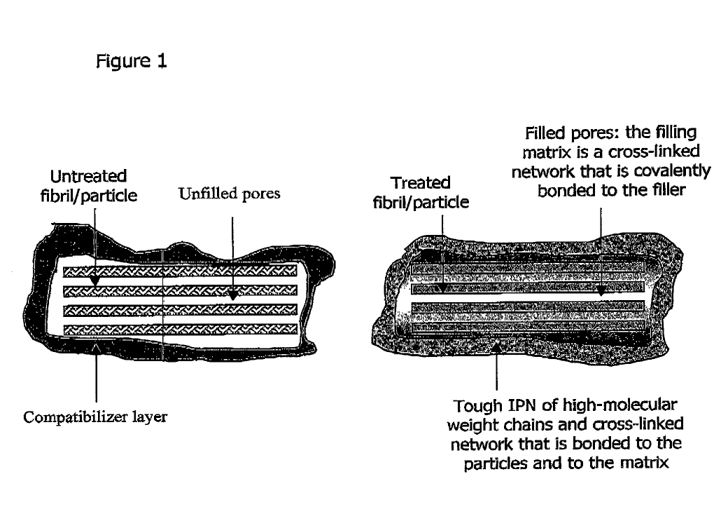

FIG. 1 illustrates a comparison between the resulting product obtained by treating a porous material with a common compatibilizer of the prior art compared to the same material treated with the CCA1 and an organic solvent according to the present invention. Thus, while according to the prior art the compatibilizer wraps the surface of the fiber leaving the inner parts unmodified, the resulting inner part of the fibrous porous material treated with the CCA1 according to the present invention is modified. The inner fibril or particle, which are untreated by common compatibilizer, is chemically modified by the CCA1 solvent system, Furthermore, the pores between fibers, which are left untreated by the compatibilizer of the prior art due to the fact that the compatibilier cannot penetrate inside, are filled by the various ingredients of the CCA1 so as to form an inner cross-linked network. However due to the nanosize-defined structure, the high molecular fractions of CCA1 are barred from migrating to the inner part leading to the formation of a tough and strong interphase. This is in contrast to standard coupling agent, which create a brittle interposed.

After the treatment of the fibrous porous material with the CCA1 solution, the solvent is removed from the mixture by any known technique such as vacuum or condensation yielding a product. The resulting treated material, which may be a powder or chip depending on the starting material, is hydrophobic and may be stored at ambient temperature for a period of a few months with no decrease in the chemical reactivity.

The resulting treated fibrous porous material may be used as an active additive for the manufacture of composite materials. Thus the treated fibrous porous filler product may be used as an extremely efficient cost-effective improved compatibilizer for stabilizing polymer-polymer interactions. The composite material is comprised of a resin and the treated fibrous porous material. The resin may be any thermoplastic or theremosetting polymers, multilayered or multicomponent products, their mixtures or any post consumer plastic mixture.

In order to manufacture composites, the treated fibrous porous material may be mixed by simple mechanical mixer at ambient temp. and pressure with the appropriate thermoplastic or thermosetting polymers in the form of as fine powder or granules or extruded with the polymers at an elevated temperature, typically by twin-screw extruder. Any standard mixing equipment (planetary mixer, banburny, roll mill, sigma mixer, single and twin screw extruder) may be used. The resulting composition is then further preheated and pressurized at a temperature from about 120° C. to about 190° C. under a pressure from about 10 to about 60 atm. to yield a strong, stiff and durable composite material. It should be understood that under the processing and molding conditions, the reactive ingredients promote chemical reaction between the matrix and the interposed which in turn are responsible for the extraordinary properties of the resulting composite. When the matrix is based on more than one polymer—the treated porous fibers act as compatibilizer: on the macroscopic level, the fibers adsorb the polymers and limit the flow and phase separation. On the microscopic level, the reactive group attached to the surface, react with the different polymers and stabilize them Contrary to polymeric compatibilizers that dissolve and migrate from the interface, the fibers of the chosen material stabilize the chemical reactive groups. In complicated situations of commingled plastics, the resulting product minimizes the phase separation and stabilizes phases by chemical reactions. The reactions that may take place are for example vinyl polymers may be bonded by radical polymerization (HDPE, PP, LDPE, PVC, PS) and condensation polymers by transesterification (PET).

The composite material manufactured according to the invention may be shaped into the desired product such as plates, boards, films carrying surfaces etc.

Furthermore, preforms may be manufactured from the composites of the present invention by shaping the extruded or mixed composite mixture into mold, rolls or as continuous belt to give sheet of material. Alternatively, a preform may be manufactured by impregnating the extruded or mixed composite mixture into a woven or non-woven fabric.

The letter application results in a structure whose properties of stiffness, impact, cost-effectivness, wear and creep resistance are improved significantly compared to known monolythic structure. Such a structure may be made in the following manner. First a “skin” is made by co-weaving of a fabric selected from the group comprising of glass, ceramic material, kevlar, carbon, metal, nylon, cellulose based material, in a mold, rolls or continuous belt, to give a sheet of the material where the fabric is impregnated with a thermoplastic or thermosetting resin. The produced “skin” is then laminated at a temperature of about 160° C. to about 180° C. with a composite material as described above polymer with treated fibrous porous filler), resulting in a lightweight strong sandwich structure. Flame-retardants may be added to the “skin” providing a self-extinguishing fabric. The introduction of flame retardant into the “skin” matrix make the structure self-extinguishing due to a synergic effect. The high temperature resistant fabric prevent the cracking during eposure to flame, thus keeping the thin flame resistant layer intact and minimizing supply of fresh depolymerized monomers to the surface.

### EXAMPLES

### Example 1

### Ccomposite Material Made from Treated Newsprint and Commingled Post Consumer Plastic, by Simple Mixing at Ambient Temperature

A solution containing 7.5 g. Ethyl acetate and 30 g. of Cyletec Coupling Agent 1 (CCA1, produced by Recycling Technologies Ltd., Israel) was prepared. The solution was mixed with 241 g. of newsprint chips (5 mm), in planetary mixer at ambient temperature for 10 minutes. 257 g. of post consumer plastic mixture (90% HDPE 5% PET, 5% packaging multilayered material) chopped to 5 mm chips were added and mixed for 10 min. The ethyl acetate was regenerate by vacuum/ condensation. The mixture was heated to 135° C. under a pressure of 10 atm. for 5 min. to create a packed Preform. The Preform was preheated to 150° C. and pressed at 180° C. under a pressure of 45-atm. for 50 minutes and the demolding temperature is 70° C. The flexural stress-strain properties are described in Table I. The material is stiff with modulus of 2550 Mpa and flexural strength of 45 Mpa. The impact strength measured by falling dart was 3-4 times higher then mixture without the coupling agent. Water absorption is less than 0.5% (despite the fact that about 50% of the material is cellulose). Unlike standard cellulose based composites that suffer from oxidation (burning) of the cellulose, during molding—this composite material was bright-colored and had no smell of smoke.

Very similar results were achieved when a virgin HDPE was used as the polymer matrix.

### Example 2

### Composite Material Made from Treated Newsprint and Commingled post Consumer Plastic, by Extrusion Compounding

A solution containing 7.5 g. Ethyl acetate and 30 g. of CCA1 (produced by Recycling Technologies Ltd., Israel) was prepare. The solution was mixed with 241 g. of newsprint (5 mm), in planetary mixer at ambient temperature for 10 minutes. 257 g. of post consumer plastic mixture (90% HDPE, 5% PET, 5% packaging multilayered material) chopped to 5 mm chips were added and the solution was mixed for 10 minutes. Ethyl acetate was regenerate by vacuum/ condensation. The composition of treated paper and plastic were mixed in a co-rotating twin screw extruder and the resulting preform was preheated to 150° C. and pressed under a presume of 45 atm. at 180° C. for 50 minutes, and the demolding temperature is 70° C.

The flexural stress-strain properties are described in Table I. The material is stiff with modulus of 3500 Mpa and flexural strength of 50 Mpa. Water absorption is less than 0.5% (despite the fact that about 50% of the material is cellulose). Unlike standard cellulose based composites that suffer from oxidation (burning) of the cellulose—this composite material was bright-colored and had no smell of smoke.

Very similar results were achieved when a virgin HDPE was used as the polymer matrix.

### Example 3

### Composite Material Made from Treated Newsprint Short Glass Fibers and Commingled Post Consumer Plastic by Extrusion Compounding

A solution containing 7.5 g. Ethyl acetate and 30 g. of CCA1 (produced by Recycling Technologies Ltd., Israel) was prepared. The solution was mixed with 241 g. Of newsprint chips (5 mm), in planetary mixer at ambient temperature for 10 minutes. 257 g. of post consumer plastic mixture (90% HDPE, 5% PET, 5% packaging multilayered material) chopped to 5 mm chips were added. 50 g. of 10 mm chopped glass fibers were further added and the solution was mixed for 10 min. Ethyl acetate was regenerated by vacuum/condensation. The resulting composition of the treated paper and plastic was mixed in a co-rotating twin screw extruder giving rise to a preform. The preform was preheated to 150° C. and pressed at a pressure of 45 atm. at 180° C. for 50 minutes and the demolding temperature is 70° C.

The flexural stress-strain properties are described in Table I. The material is stiff with modulus of 4500 Mpa and flexural strength of 55 Mpa. The impact strength measured by falling dart was 4-5 times higher then HDPE. Water absorption is less than 0.5% (despite the fact that about 50% of the material is 5 cellulose). Unlike standard cellulose based composites that suffer from oxidation (burning) of the cellulose—this composite material was bright-colored and had no smell of smoke.

Very similar results were achieved when a virgin HDPE was used as the polymer matrix.

### Example 4

### Composite Material Made from Treated Newsprint PVC/ABS/PE/PS by Simple Mixing at Ambient

A solution containing 7.5 g. Ethyl acetate and 30 g. of CCA1 (prodced by Recycling Technologies Ltd., Israel) was prepared. The solution was mixed with 241 g. Of newsprint chips (5 mm), in planetary mixer at ambient temperature for 10 minutes. 257 g. of virgin polymer powder was added and the solution was mixed for 10 min. Ethyl cellulose was regenerated by vacuum/ condensation. The resulting mixture was pressurized under a pressure of 10 atm. at a temperature of 35° C. for 5 minutes to create a packed preform. The Preform was preheated to 150° C. and pressurized at 180° C. under a pressure 45-atm. for 50 min. demolding temperature—70° C.

The flexural stress-stain properties are described in Table I.

TABLE I
Physical properties of starting materials and
composite materials obtained in Examples 1 to 4:

| | Flexural | Flexural |
|---|---|---|
| | Strength | Modulus |
| Description | (Mpa) | (Mpa) |
| ABS (MFI 11)-blank | 43.49 | 1409 |
| ABS/45% Paper | 25.59 | 1968 |
| ABS/Paper + CCA1 | 41.62 | 3395 |
| ABS: HDPE(50:50)/Paper + CCA1 | 38.12 | 2776 |
| PS (MFI unknown) | 40.84 | 2196 |
| PS/Paper | 15.27 | 1670 |
| PS/Paper + CCA1 | 29.17 | 3591 |
| HDPE MFI 7 | 21.74 | 818.4 |
| PS: HDPE(50:50)/Paper + CCA1 | 40.25 | 3282 |
| PVC (unplasticized) blank | 22.76 | 2912 |
| PVC: HD(50:50)/40% Paper | 23.18 | 2938 |
| PVC: HD(50:50)/40% Paper + CCA1 | 51.78 | 3914 |
| PP MFI 10 | 33.18 | 3118 |
| PP/45% Paper + CCA1 | 34.77 | 3090 |

### Example 5

### A Composite Structure Made from Treated Newsprint, PVC/ABS/PE/PS by Simple Mixing at Ambient Temperature, and Reinforced Skin Made from Unsaturated Polyester/Glass Mat

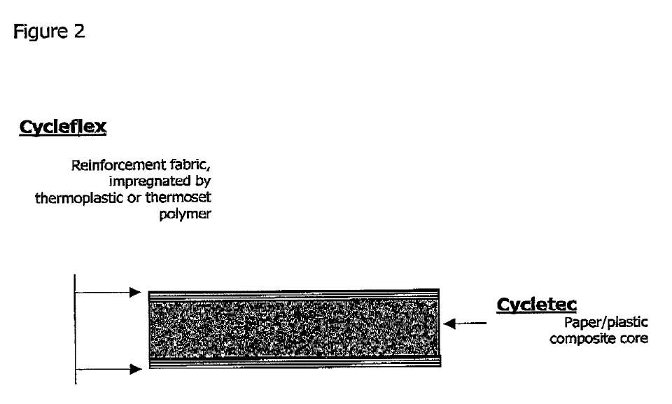

A mixture of Derakane® (510A40 by Dow), 1% (w/w) dicumyl peroxide and 5% (w/w) antimony trioxide were applied over a nonwoven E-glass (Owens, 255 gr/m²). A composite material obtained as in example 1 is laminated by the pre-preg (a tissue of reinforced fiber, impregnated by theroset resin in α-stage or β-stage) at temperature of 165° C. resulting in a sandwich structure shown in FIG. 2. The physical properties of the resulting structure are: Flexural strength of 60.31 Mpa, Flexural modulus of 4468 Mpa and the impact is 2 times better than the original core. Flame resistance: the original core material is burning after ignition of 15 seconds. The unreinforced version (Derakane skin over standard core), burn for 10 seconds, and fire was running into the cracks on surface. The reinforced version, stopped fire immediately after the flame was removed (V-0).

Although the invention has been described in conjunction with specific embodiments it is evident that many alternatives and variations will be apparent to those skilled in the art in light of the foregoing description. Accordingly, the invention is intended to embrace all of the alternatives and variations that fall within the spirit and scope of the appended claims.

1. A treated fibrous porous material having a defined nanostructure comprising reactive sites thereon, wherein said fibrous porous material is treated with a low viscosity organic solution comprising CCA1, as defined in the specification.

2. The treater fibrous porous material of claim 1, wherein said fibrous porous material is selected from the group comprising of cellulose, lignin, synthetic ceramics, porous metal nanopowders, kaolin, bio fibers and porous powders of biological origin or mixtures thereof.

3. The treated fibrous porous material of claim 1, wherein the porous material is cellulose.

4. The treated fibrous porous material of claim 3, wherein the cellulose is in the form of wood chips, newsprint material, paper chips or powder, sawdust or mixtures thereof.

5. The treated fibrous porous material of claim 4, wherein said fibrous porous is material is newsprint.

6. The treated fibrous porous material according to claim 1 for use as a reactive additive for composite materials.

7. A composite comprising a resin and a reactive additive wherein said reactive additive is comprising of a treated fibrous porous material having a defined nanostructure comprising reactive sites thereon, wherein said treatment is with a low viscosity organic solution comprising CCA1.

8. A composite according to claim 7, wherein the resin is selected from thermoplastic or thermosetting polymers, their mixtures or multilayered or multicomponent products or mixtures thereof.

9. A composite according to claim 7, wherein said resin is from industrial or domestic waste.

10. A composite according to claim 7, wherein the resin is selected from the group comprising of polyethylene and copolymers of, polypropylene and copolymers of, polystyrene and copolymers of, polycarbonate, silicones and copolymers thereof, polybutylene or polyethyleneterphthalate, polyurethane, epoxy, unsaturated polyesters, vinyl esters and ethers, acrylic resins and copolymers of, polyamides, phenolics, amino resins, alkyds, polyimides, polyethers, polyvinyl chloride and copolymers thereof, nylon and mixtures thereof.

11. A composite according to claim 7, wherein said pretreated fibrous porous material is selected from the group comprising of cellulose, lignin, synthetic ceramics, porous metal nanopowders, kaolin, bio fibers and porous powders of biological origin or mixtures thereof.

12. A composite according to claim 7, wherein the porous material is cellulose.

13. A composite according to claim 12, wherein the cellulose is in the form of wood chips, newsprint material, paper chips or powder, sawdust or mixtures thereof.

14. A composite according to claim 13, wherein the cellulose is newsprint.

15. A method of manufacturing a composite comprising of a resin and an active additive wherein the active additive is a fibrous porous material having a defined nanostructure comprising reactive sites thereon treated with a low viscosity solution comprising CCA1, wherein said method is comprised of removing the solvent; said resin and active additive are mixed or extruded, said mixing or extrusion are carried at an ambient or elevated temperature and the resulting composition molded direct from extruder or further preheated and compression molded at a temperature of about from 120° C. to about 190° C. under a pressure of about 10 to about 60 atm.

16. The method according to claim 15, wherein the resin is selected from thermoplastic or thermosetting polymers, their mixtures or any domestic or industrial multilayered or multi-component products.

17. The method according to claim 15, wherein the resin is from industrial or domestic waste.

18. The method according to claim 15, wherein the resin is selected from the group comprising of polyethylene and copolymers of, polypropylene and copolymers thereof, polystyrene and copolymers of, polycarbonate, silicones and copolymers thereof, polybutylene or polyethyleneterphthalate, polyurethane, epoxy, unsaturated polyesters, vinyl esters and ethers, acrylic resins and copolymers thereof, polyamides, phenolics, amino resisns, alkyds, , polyimides, polyethers, polyvinyl chloride and copolymers thereof, nylon and mixtures thereof.

19. The method according to claim 15, wherein the fibrous porous material is selected from the group comprising of cellulose, lignin, synthetic ceramics, porous metal nanopoders, kaolin, bio fibers and porous powders of biological origin or mixtures thereof.

20. The method according to claim 15, wherein the porous material is cellulose.

21. The method according to claim 20, wherein the cellulose is in the form of wood chips, paper chips or powder, sawdust or mixtures thereof.

22. Plates manufactured from the composite of claim 7 by the method of claim 15.

23. Boards manufactured from the composite of claim 7 by the method of claim 15.

24. Films manufactured from the composite of claim 7 by the method of claim 15.

25. Carrying surfaces manufactured from the composite of claim 7 by the method of claim 15.

26. A preform manufactured from the composite of claim 7, by shaping the extruded or mixed composite mixture into a mold, rolls or continuous belt, to give a sheet of the material

27. A preform manufactured from the composite of claim 7, by impregnating the extruded or mixed composite mixture into a woven or non-woven fabric selected from the group comprising of glass, ceramic material, kevlar, carbon, metal, nylon, cellulose based material, in a mold, rolls or continuous belt, to give a sheet of the material.

28. A composite structure manufactured by heating at least one preform of claim 26 or 27 to a softening point and pressing the pre-heated sheet in a mold by compression molding.

29. A composite structure manufactured by heating two or more different preforms of claim 26 or 27 to a softening point and pressing the pre-heated sheets in a mold by compression molding, to give a multilayered structures

30. A composite according to claim 28 wherein the softening point is from about 130° C. to about 170° C.

31. A composite according to claim 29 wherein the softening point is from about 130° C. to about 170° C.

32. A process for production of final shaped parts by compounding in extuder a resin and fibrous porous material having a defined nanostructure comprising reactive sites thereon treated with a low viscosity organic solution comprising CCA1, followed by injection molding.

33. A process according to claim 32, wherein the resin is selected from thermoplastic or thermosetting polymers, their mixtures or multilayered or multicomponent products or mixtures thereof.

34. A process according to claim 32, wherein said resin is from industrial or domestic waste.

35. A process according to claim 32, wherein the resin is selected from the group comprising of polyethylene and copolymers of, polypropylene and copolymers of, polystyrene and copolymers of, polycarbonate, silicones and copolymers thereof, polybutylene or polyethyleneterphthalate, polyurthane, epoxy, unsaturated polyesters, vinyl esters and ethers, acrylic resins and copolymers of, polyamides, phenolics, amino resins, alkyds, polyimides, polyethers, polyvinyl chloride and copolymers thereof, nylon and mixtures thereof.

36. A process according to claim 32, wherein said treated fibrous porous material is selected from the group comprising of cellulose, lignin, syntetic ceramics, porus metal nanopowders, kaolin, bio fibers and porous powders of biological origin or mixtures thereof.

37. A process according to claim 32, wherein the porous material is cellulose.

38. A process according to claim 37, wherein the cellulose is in the form of wood chips, newsprint material, paper chips or powder, sawdust or mixtures thereof.

39. A process according to claim 38, wherein the cellulose is newsprint.

40. A process for production of final shaped parts by compounding in extruder a resin and a fibrous porous material having a defined nanostructure comprising reactive sites thereon treated with a low viscosity organic solution comprising CCA1, followed by injection-compression molding.

41. A process according to claim 40, wherein the resin is selected from thermoplastc or thermosetting polymers, their mixtures or multilayered or multicomponent products or mixtures thereof.

42. A process according to claim 40, wherein said resin is from industrial or domestic waste.

43. A process according to claim 40, wherein the resin is selected from the group comprising of polyethylene and copolymers of, polypropylene and copolymers of, polystyrene and copolymers of, polycarbonate, silicones and copolymers thereof, polybutylene or polyethyleneterphthalate, polyurethane, epoxy, unsaturated polyesters, vinyl esters and ethers, acrylic resins and copolymers of, polyamides, phenolics, amino resins, alkyds, polyimides, polyethers, polyvinyl chloride and copolymers thereof, nylon and mixtures thereof.

44. A process according to claim 40, wherein said preheated fibrous porous material is selected from the group comprising of cellulose, lignin, synthetic ceramics, porous metal nanopowders, kaolin, bio fibers and porous powders of biological origin or mixtures thereof.

45. A process according to claim 40, wherein the porous material is cellulose.

46. A process according to claim 45, wherein the cellulose is in the form of wood chips, newsprint material, paper chips or powder, sawdust or mixtures thereof.

47. A process according to claim 46, wherein the cellulose is newsprint.

48. A process for production of final shaped parts by compounding in extruder a resin and a fibrous porous material having a defined nanostructure comprising reactive sites thereon, with a low viscosity organic solution comprising CCA1, wherein the molded extruded material is transferred into an open mold followed by compression molding to final shaped parts.

49. A process according to claim 48, wherein the resin is selected from thermoplastic or thermosetting polymers, their mixtures or multilayered or multicomponent products or mixtures thereof.

50. A process according to claim 48, wherein said resin is from industrial or domestic waste.

51. A process according to claim 48, wherein the resin is selected from the group comprising of polyethylene and copolymers of, polypropylene and copolymers of, polystyrene and copolymers of, polycarbonate, silicones and copolymers thereof, polybutylene or polyethyleneterphthalate, polyurethane, epoxy, unsaturated polyesters, vinyl esters and ethers, acrylic resins and copolymers of, polyamides, phenolics, amino resins, alkyds, polyimides, polyethers, polyvinyl chloride and copolymers thereof, nylon and mixtures thereof.

52. A process according to claim 48, wherein said preheated fibrous porous material is selected from the group comprising of cellulose, lignin, synthetic ceramics, porous metal nanopowders, kaolin, bio fibers and porous powders of biological origin or mixtures thereof.

53. A process according to claim 48, wherein the porous material is cellulose.

54. A process according to claim 53, wherein the cellulose is in the form of wood chips, newsprint material, paper chips or powder, sawdust or mixtures thereof.

55. A process according to claim 54, wherein the cellulose is newsprint.
